(19) United States
(12) Patent Application Publication
(10) Pub. No.: US 2008/0238896 A1
(43) Pub. Date: Oct. 2, 2008

(54) Data driving device, display apparatus having the same and method of driving the same

(75) Inventor: Dong-Gyu Kim, Yongin-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/005,902

(22) Filed: Dec. 28, 2007

(30) Foreign Application Priority Data
Mar. 27, 2007 (KR) 10-2007-0029931

(51) Int. Cl. G06F 3/038

(52) U.S. Cl. 345/204

(57) ABSTRACT

In a data driving device, a display apparatus having the data driving device and a method of driving the data driving device, an input circuitry receives an image data signal in a digital form from an exterior, and a converter converts the image data signal from the input circuitry into a data voltage in an analog form. An output buffer amplifies the data voltage from the converter. Based on the data voltage amplified by the output buffer, a voltage divider outputs two or more pixel voltages having different voltage levels from each other. Thus, a size of the output buffer and the converter may be reduced while increasing the number of pixel voltages output from the data driving device.

### CROSS-REFERENCE TO RELATED APPLICATION

This application claims the benefit of priority from Korean Patent Application No. 10-2007-29931 filed on Mar. 27, 2007 in the Korean Intellectual Property Office, the contents of which are herein incorporated by reference in its entirety.

### BACKGROUND OF THE INVENTION

1. Field of the Invention

The present invention relates to a data driving device, a display apparatus having the data driving device and a method of driving the data driving device. More particularly, the present invention relates to a data driving device for a super-patterned vertical alignment (S-PVA) mode display apparatus, a display apparatus having the data driving device and a method of driving the data driving device.

2. Description of the Related Art

In general, a liquid crystal display (LCD) includes an LCD panel having a lower substrate, an upper substrate facing the lower substrate and a liquid crystal layer interposed between the lower substrate and the upper substrate in order to display an image. The LCD panel includes a plurality of gate lines, a plurality of data lines and a plurality of pixels connected to the gate lines and the data lines.

In comparison with other types of display apparatuses, the LCD has a narrow viewing angle. In order to improve the viewing angle of the LCD, techniques such as a Patterned Vertical Alignment (PVA) mode, a Multi-domain Vertical Alignment (MVA) mode and a Super-Patterned Vertical Alignment (S-PVA) mode for the LCD have been developed to widen the viewing angle characteristics.

The S-PVA mode LCD includes a plurality of pixels each of which has a main pixel and a sub-pixel. In order to form domains having different gray-scales in one pixel, a main pixel electrode and a sub-pixel electrode are arranged in the main pixel and the sub-pixel, respectively, and the main and sub-pixel electrodes receive main and sub-pixel voltages having different voltage levels from each other. Human eyes recognize an improved visibility resulting from the use of an intermediate value of the main and sub-pixel voltages, so that a side viewing angle caused by a gamma curve that is distorted under an intermediate gray-scale may be prevented from being narrowed, thereby improving a side visibility of the S-PVA mode LCD.

The S-PVA mode LCDs can be classified into a Coupling Capacitor-type (CC-type), and a Two Transistor-type (TT-type), based on the driving method used. The CC-type is driven by a method that drops a data voltage applied to the sub-pixel electrode in order to provide a lower voltage than the main pixel voltage, which is achieved by adding a coupling capacitor between the main and sub-pixel electrodes. The TT-type is driven by a method that applies main and sub-pixel voltages having different voltage levels from each other to the main and sub-pixel electrodes, respectively, using two transistors.

The TT-type is classified into a 2G-1D type in which one pixel is connected to two gate lines and one data line, and a 1G-2D type in which one pixel is connected to one gate line and two data lines. In case of the 1G-2D type, since the main pixel voltage and the sub-pixel voltage are substantially simultaneously output from a data driving device, a size of the data driving device increases by two times than that of the 2G-1D type, thereby increasing the manufacturing cost of the data driving device.

### SUMMARY OF THE INVENTION

In one embodiment of the present invention provides a data driving device for an S-PVA mode display apparatus using the 1G-2D type driving method is provided.

In another embodiment of the present invention, a display apparatus having the data driving device is provided.

In yet another embodiment of the present invention, a method of driving the data driving device is provided.

In embodiment of present invention, a data driving device includes an input circuitry, a converter, an output buffer and a voltage divider. The input circuitry receives an image data signal in a digital form from an exterior, and the converter converts the image data signal from the input circuitry into a data voltage in an analog form. The output buffer receives the data voltage from the converter and amplifies the data voltage. The voltage divider receives the amplified data voltage from the output buffer and outputs a plurality of pixel voltages having different voltage levels from each other.

In embodiment of present invention, a data driving device includes an input circuitry, a converter, a voltage divider and an output buffer. The input circuitry receives an image data signal in a digital form from an exterior, and the converter converts the image data signal from the input circuitry into a first pixel voltage in an analog form. The voltage divider outputs the first pixel voltage from the converter and outputs a second pixel voltage having a different voltage level from that of the first pixel voltage based on the first pixel voltage from the converter. The output buffer amplifies the first pixel voltage and the second pixel voltage from the voltage divider and outputs the amplified first and second pixel voltages.

In embodiment of present invention, a display apparatus includes a gate driver, a data driver and a display part. The gate driver sequentially outputs a gate signal, and the data driver substantially simultaneously outputs a first pixel voltage and a second pixel voltage having different voltage levels from each other. The display part includes a plurality of pixels to display an image. Each of the pixels includes a first pixel and a second pixel that display different gray-scales, and the first and second pixels receive the first pixel voltage and the second pixel voltage in response to the gate signal, respectively.

The data driver includes an input circuitry, a converter, an output buffer and a voltage divider. The input circuitry receives an image data signal in a digital form, and the converter converts the image data signal in a digital form from the input circuitry into a data voltage in an analog form based on a gamma reference voltage. The output buffer receives the data voltage from the converter and amplifies the data voltage. The voltage divider outputs a plurality of pixel voltages based on the amplified data voltage from the output buffer.

In embodiment of present invention, a method of driving a data driving device is provided as follows. When an image data signal in a digital form is input, the image data signal is converted into a data voltage in an analog form. The data voltage is amplified, and the amplified data voltage is voltage-divided into a plurality of pixel voltages having different voltage levels from each other.

In embodiment of present invention, a method of driving a data driving device is provided as follows. When an image data signal in a digital form is input from an exterior, the image data signal is converted into a first pixel voltage in an analog form. The first pixel voltage is output, and a second pixel voltage having a different voltage level from that of the first pixel voltage is output based on the first pixel voltage. Then, the first and second pixel voltages are amplified.

According to the above, the voltage divider that outputs the main and sub-pixel voltages having different voltage levels based on the data voltage is arranged next to the D/A converter or the output buffer. Thus, the size of the D/A converter may decrease and the number of Op-amps arranged in the output buffer may be reduced.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram showing an exemplary embodiment of a data driving device according to a first embodiment of the present invention;

FIG. 2 is a circuit diagram showing a portion of an output buffer and a voltage, divider of a first type usable for the embodiment of FIG. 1;

FIG. 3 is a circuit diagram showing a portion of an output buffer, and a voltage divider of a second type usable for the embodiment of FIG. 4 is a block diagram showing an exemplary embodiment of a data driving device according to a second embodiment of the present invention;

FIG. 5 is a circuit diagram showing a voltage divider of a first type, and a portion of an output buffer usable for the embodiment of FIG. 4;

FIG. 6 is a circuit diagram showing a voltage divider of a second type and a portion of an output buffer usable for the embodiment of FIG. 4;

FIG. 7 is a block diagram showing a third exemplary embodiment of a liquid crystal display according to the present invention; and

FIG. 8 is a circuit diagram showing parts of a display and of a data driver according to an embodiment of the present invention for use in the system shown in FIG. 7.

### DESCRIPTION OF THE EMBODIMENTS

Hereinafter, embodiments of the present invention are explained in detail with reference to the accompanying drawings. In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

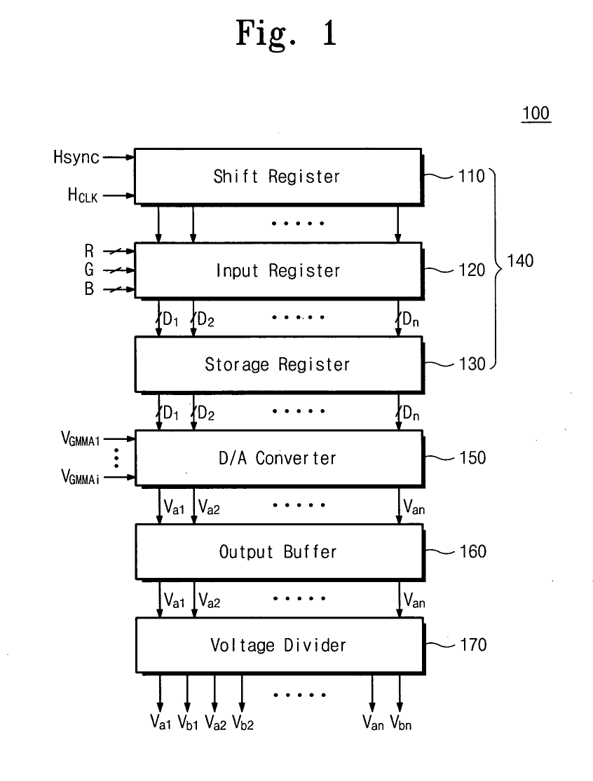

FIG. 1 is a block diagram showing an exemplary embodiment of a data driving device according to a first embodiment of the present invention.

Referring to FIG. 1, a data driving device 100 includes an input circuitry 140, a D/A converter 150, an output buffer 160 and a voltage divider 170.

The input circuitry 140 includes a shift register 110, an input register 120 and a storage register 130. The shift register 110 includes a plurality of stages connected one after another to each other, and receives a horizontal synchronization signal Hsync and a horizontal clock signal H_{CLK} from external source. The shift register 110 starts its operation in response to the horizontal synchronization signal Hsync, and the stages are sequentially turned on to provide the horizontal clock signal H_{CLK} to the input register 120 as an output signal during a high period of the horizontal clock signal H_{CLK}.

The input register 120 receives image data signals R, G, B in digital form from an external source. The input register 120 sequentially stores the image data signals R, G, B in synchronization with the horizontal clock signal H_{CLK}. Thus, the image data signals (hereinafter, referred to as first to n-th image data signals) D1˜Dn corresponding to one line are stored in the input register 120. In the present exemplary embodiment, each of the first to n-th image data signals D1˜Dn includes 10 bits.

Then, the first to n-th image data signals D1˜Dn stored in the input register 120 are substantially simultaneously output and stored in the storage register 130.

The D/A converter 150 receives the first to n-th image data signals D1˜Dn from the storage register 130 and receives first to i-th gamma reference voltages V_{GAMMA}1˜V_{GAMMA}i from an external source. The D/A converter 150 converts the first to n-th image data signals D1˜Dn into first to n-th main pixel voltages Va1˜Van in an analog form based on the first to i-th gamma reference voltages V_{GAMMA}1˜V_{GAMMA}i.

The first to n-th main pixel voltages Va1˜Van are provided to the output buffer 160, and the output buffer 160 amplifies and outputs to voltage divider 170/175 the first to n-th main pixel voltages Va1˜Van.

The voltage divider 170/175 receives the first to n-th main pixel voltages Va1˜Van from the output buffer 160 and outputs first to n-th main pixel voltages Va1˜Van and first to n-th sub-pixel voltages Vb1˜Vbn having different voltage levels from the first to n-th main pixel voltages Va1˜Van. More particularly, the voltage divider 170/175 receives n main pixel voltages and outputs n main pixel voltages and n sub-pixel voltages.

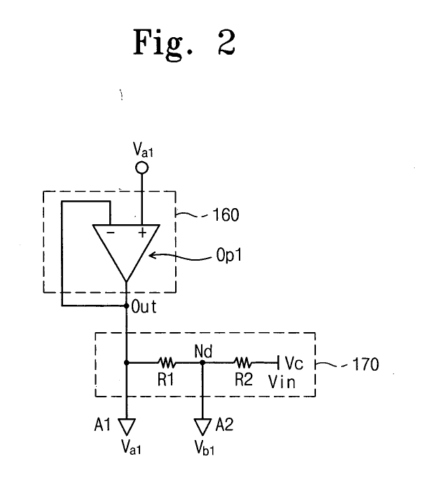

FIG. 2 is a circuit diagram showing a portion of an output buffer and a voltage divider of a first type usable for the embodiment of FIG. 1;

In FIG. 1, the output buffer 160 includes first to n-th operational amplifiers (Op-amps) in order to amplify each of the first to n-th main pixel voltages Va1˜Van. In FIG. 2, however, for simplicity of explanation, only a first Op-amp Op1 that amplifies the first main pixel voltage Va1 is described below in detail, and thus the detailed descriptions of remaining n−1 Op-amps is unnecessary since they are like configured.

Referring to FIG. 2, a first Op-amp Op1 receives the first main pixel voltage Va1 and amplifies the first main pixel voltage Va1 to a predetermined level to output the first main pixel voltage Va1. The amplified first main pixel voltage Va1 is applied to the voltage divider 170.

The voltage divider 170 includes a first output terminal A1 outputting the first main pixel voltage Va1 and a second output terminal A2 outputting a first sub-pixel voltage Vb1 having a lower voltage level than that of the first main pixel voltage Va1. The voltage divider 170 includes a first resistor R1 and a second resistor R2 that are connected to the first Op-amp Op1 in order to generate the first sub-pixel voltage Vb1. Although not shown in FIG. 2, the voltage divider 170 may further include n−1 first resistors R1 and n−1 second resistors R2 both of that are electrically connected to each of the remaining (n−1) Op-amps.

The first resistor R1 and the second resistor R2 are connected in series between an output terminal Out of the first Op-amp Op1 and a voltage input terminal Vin. In the present exemplary embodiment, a common voltage Vc is applied to the voltage input terminal Vin.

The first output terminal A1 of the voltage divider 170 is electrically connected to the output terminal Out of the first Op-amp Op1, and the second output terminal A2 of the voltage divider 170 is electrically connected to a node Nd where the first resistor R1 and the second resistor R2 are connected to each other. Thus, the first main pixel voltage Va1 provided from the first Op-amp Op1 is output through the first output terminal A1, and the first main pixel voltage Va1 is voltage-divided by the first resistor R1 and the second resistor R2 to output the first sub-pixel voltage Vb1 having the lower voltage level than that of the first main pixel voltage Va1 through the second output terminal A2.

The first sub-pixel voltage Vb1 satisfies an equation 1 as follows.

$$Vb 1 = \frac{R 2}{R 1 + R 2} ( Va 1 - Vc ) + Vc \qquad Equation 1$$

In equation 1, Vb1 represents the first sub-pixel voltage, Va1 represents the first main pixel voltage, Vc represents the common voltage, R1 represents the first resistor, and R2 represents the second resistor.

As shown in equation 1, since the first main pixel voltage Va1 is voltage-divided by a ratio between the first and second resistors R1 and R2, the first sub-pixel voltage Vb1 has the lower voltage level than that of the first main pixel voltage Va1. In the present exemplary embodiment, a size of the first resistor R1 and the second resistor R2 may be set allowing the first sub-pixel Vb1 to have a voltage level of about 0.7 times than that of the first main pixel voltage Va1. However, a voltage level of the first sub-pixel voltage Vb1 is not limited to the level and may be varied within a voltage level range lower than that of the first main pixel voltage Va1.

Referring to FIG. 1 again, each of the D/A converter 150 and the output buffer 160 includes n output terminals, however, the voltage divider 170 includes 2n output terminals in order to output the first to n-th main pixel voltages Va1˜Van and the first to n-th sub-pixel voltages Vb1˜Vbn. More particularly, the voltage divider 170 outputs the first to n-th main pixel voltages Va1˜Van through the n output terminals and outputs the first to n-th sub-pixel voltages Vb1˜Vbn having the lower voltage level than that of the first to n-th main pixel voltages Va1˜Van through remaining n output terminals.

Thus, in the data driving device 100 receiving n image data signals to output 2n pixel voltages, a size of each of the input circuitry 140, the D/A converter 150 and the output buffer 160 may be prevented from increasing, and the number of Op-amps arranged in the output buffer 160 may decrease, thereby reducing a manufacturing cost of the data driving device 100.

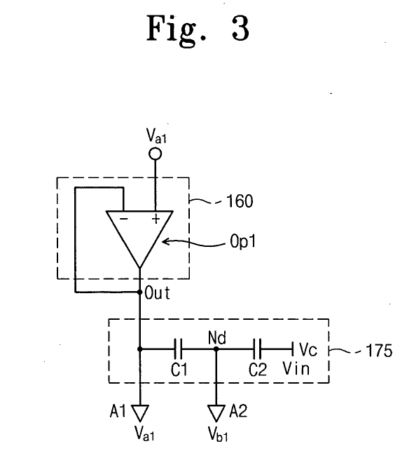

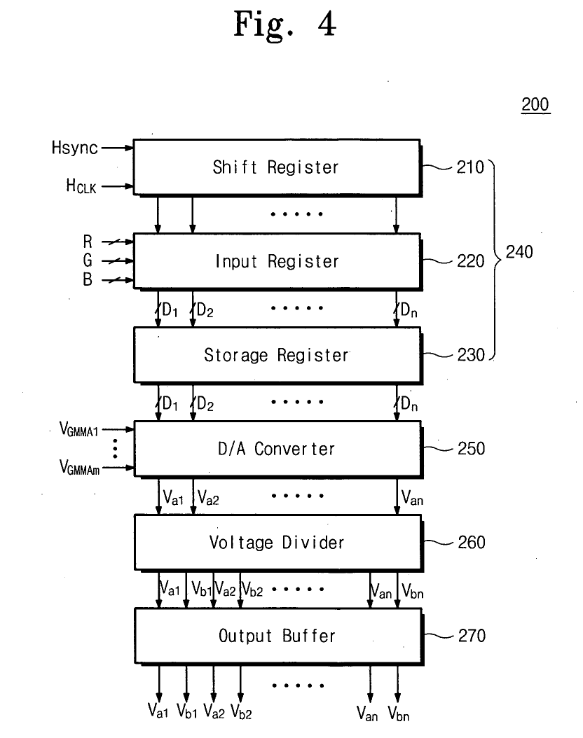

FIG. 3 is a circuit diagram showing another exemplary embodiment of parts of an output buffer and voltage divider 175 which may be employed in the system of FIG. 1 as an alternative to voltage divider 170. In FIG. 3, the same reference numerals denote the same elements in FIG. 2, and thus the detailed descriptions of the same elements are unnecessary. Also, in FIG. 3, only a first Op-amp Op1 amplifying a first main pixel voltage Va1, and a first capacitor C1 and a second capacitor C2 that are connected to the first Op-amp Op1 are described below in detail, and a detailed descriptions of n−1 Op-amps is unnecessary.

Referring to FIG. 3, a voltage divider 175 includes a first output terminal A1 electrically connected to an output terminal Out of the first Op-amp Op1 and a second output terminal A2 electrically connected to a node Nd where the first capacitor C1 and the second capacitor C2 are connected to each other. Thus, the first main pixel voltage Va1 output from the output terminal Out of the first Op-amp Op1 is output through the first output terminal A1, and the first main pixel voltage Va1 is voltage-divided by the first capacitor C1 and the second capacitor C2 to output a first sub-pixel voltage Vb1 having a lower voltage level than that of the first main pixel voltage Va1 through the second output terminal A2.

More particularly, the first sub-pixel voltage Vb1 satisfies an equation 2 as follows.

$$Vb 1 = \frac{C 1}{C 1 + C 2} ( Va 1 - Vc ) + Vc \qquad Equation 2$$

In equation 2, Vb1 represents the first sub-pixel voltage, Va1 represents the first main pixel voltage, Vc represents a common voltage, C1 represents the first capacitor, and C2 represents the second capacitor.

As shown in equation 2, since the first main pixel voltage Va1 is voltage-divided by a ratio between the first and second capacitors C1 and C2, the first sub-pixel voltage Vb1 has a lower voltage level than that of the first main pixel voltage Va1. In the present exemplary embodiment, a size of the first capacitor C1 and the second capacitor C2 may be set allowing the first sub-pixel Vb1 to have a voltage level of about 0.7 times than that of the first main pixel voltage Va1. However, the voltage level of the first sub-pixel voltage Vb1 is not limited to this and may be varied within a voltage level range that are lower than the first main pixel voltage Va1.

FIG. 4 is a block diagram showing an exemplary embodiment of a data driving device according to a second embodiment of the present invention.

Referring to FIG. 4, a data driving device 200 includes an input circuitry 240, a D/A converter 250, a voltage divider 260 and an output buffer 270. The input circuitry 240 includes a shift register 210, an input register 220 and a storage register 230 to output first to n-th image data signals D1˜Dn. The D/A converter 250 receives the first to n-th image data signals D1˜Dn and converts the first to n-th image data signals D1˜Dn into first to n-th main pixel voltages Va1˜Van based on first to i-th gamma reference voltages V_{GAMMA}1˜V_{GAMMA}i.

The input circuitry 240 and the D/A converter 250 have the same structures and functions as those of the input circuitry 140 and the D/A converter 150 shown in FIG. 1, and thus the detailed descriptions of the input circuitry 240 and the D/A converter 250 will be omitted in FIG. 4.

The voltage divider 260/265 receives the first to n-th main pixel voltages Va1˜Van from the D/A converter 250 and outputs the first to n-th main pixel voltages Va1˜Van and first to n-th sub-pixel voltages Vb1˜Vbn. Each of the first to n-th sub-pixel voltages Vb1˜Vbn has a predetermined voltage level that is lower than a corresponding main pixel voltage of the first to n-th main pixel voltages Va1 ˜Van.

The output buffer 270 receives the first to n-th main pixel voltages Va1˜Van and the first to n-th sub-pixel voltages Vb1˜Vbn from the voltage divider 260 and amplifies the first to n-th main pixel voltages Va1˜Van and the first to n-th sub-pixel voltages Vb1˜Vbn by a predetermined voltage level.

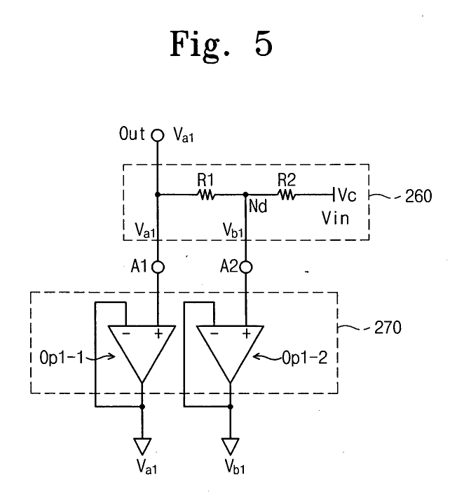

FIG. 5 is a circuit diagram showing parts of the voltage divider and the output buffer of FIG. 4.

Referring to FIG. 5, the voltage divider 260 includes a first resistor R1 and a second resistor R2 connected in series between a voltage input terminal Vin and an output terminal Out of the D/A converter 250. The first main pixel voltage Va1 is applied through the output terminal Out of the D/A converter 250, and the output terminal Out of the D/A converter 250 is connected to a first output terminal A1 of the voltage divider 260. A second output terminal A2 of the voltage divider 260 is connected to a node Nd where the first resistor R1 and the second resistor R2 are connected to each other.

Thus, the first main pixel voltage Va1 provided from the D/A converter 250 is output through the first output terminal A1, and the first main pixel voltage Va1 is voltage-divided by the first resistor R1 and the second resistor R2 to output a first sub-pixel voltage Vb1 having a lower voltage level than that of the first main pixel voltage Va1 through the second output terminal A2.

The output buffer 270 includes a first main Op-amp Op1-1 connected to the first output terminal A1 of the voltage divider 260 and a first sub Op-amp Op1-2 connected to the second output terminal A2 of the voltage divider 260. The first main Op-amp Op1-1 receives the first main pixel voltage Va1 from the voltage divider 260 and amplifies the first main pixel voltage Va1. The first sub Op-amp Op1-2 receives the first sub-pixel voltage Vb1 from the voltage divider 260 and amplifies the first sub-pixel voltage Vb1.

According to another exemplary embodiment of the present invention, since the voltage divider 260 is connected between the D/A converter 250 and the output buffer 270, the number of pixel voltages output from the D/A converter 250 decreases by half compared to the number of the pixel voltages output from the output buffer 270. Consequently, a size of the D/A converter 250 decreases and a size of the data driving device 200 may decrease, so that the manufacturing cost of the data driving device 200 may be reduced.

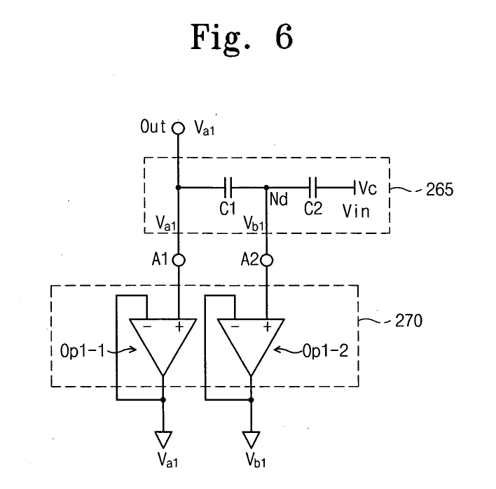

FIG. 6 is a circuit diagram showing another exemplary embodiment of the voltage divider of FIG. 4. In FIG. 6, the same reference numerals denote the same elements in FIG. 5, and thus the detailed descriptions of the same elements will be omitted.

Referring to FIG. 6, a voltage divider 265 includes a first capacitor C1 and a second capacitor C2 connected in series between the voltage input terminal Vin and the output terminal Out of the D/A converter 250 (shown in FIG. 4).

The voltage divider 265 receives the first main pixel voltage Va1 from the D/A converter 250 and outputs the first main pixel voltage Va1 through the first output terminal A1. Also, the first main pixel voltage Va1 is voltage-divided by the first capacitor C1 and the second capacitor C2, and the voltage divider 265 outputs the first sub-pixel voltage Vb1 having the lower voltage level than that of the first main pixel voltage Va1 through the second output terminal A2.

The first main pixel voltage Va1 and the first sub-pixel voltage Vb1 output from the voltage divider 265 are amplified by the first main Op-amp Op1-1 and the second sub Op-amp Op1-2 arranged in the output buffer 270, respectively.

As shown in FIGS. 1 to 6, the above-described voltage dividers 170, 175, 260 and 265 receive the n pixel voltages and output the 2n pixel voltages. However, when the number of resistors or capacitors arranged in the voltage dividers 170, 175, 260 and 265 increases, the input pixel voltages may be voltage-divided into the output pixel voltages that are about 3 times or greater than the number of input pixel voltages.

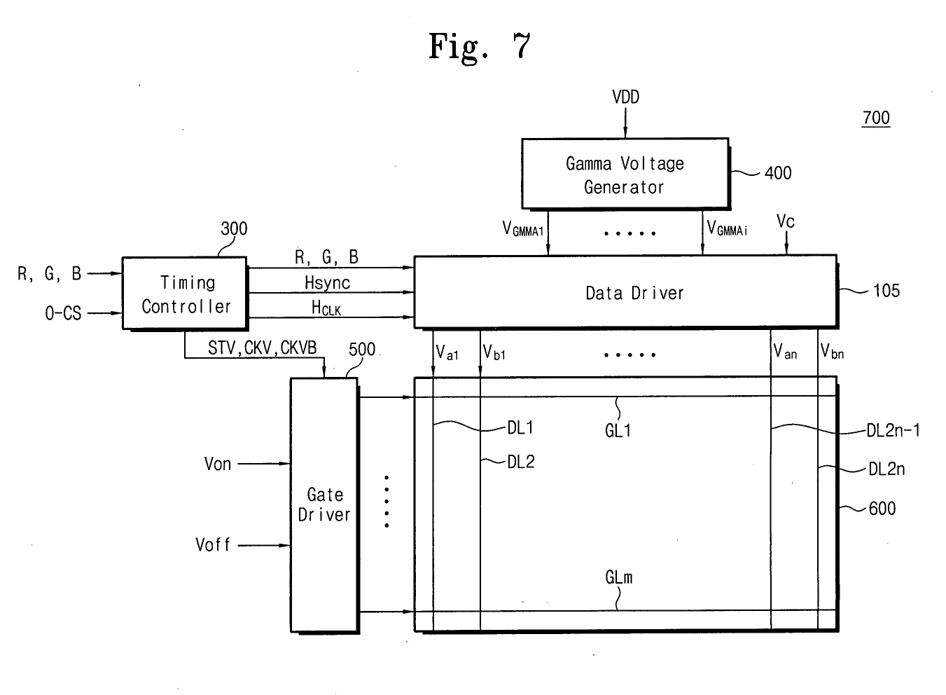

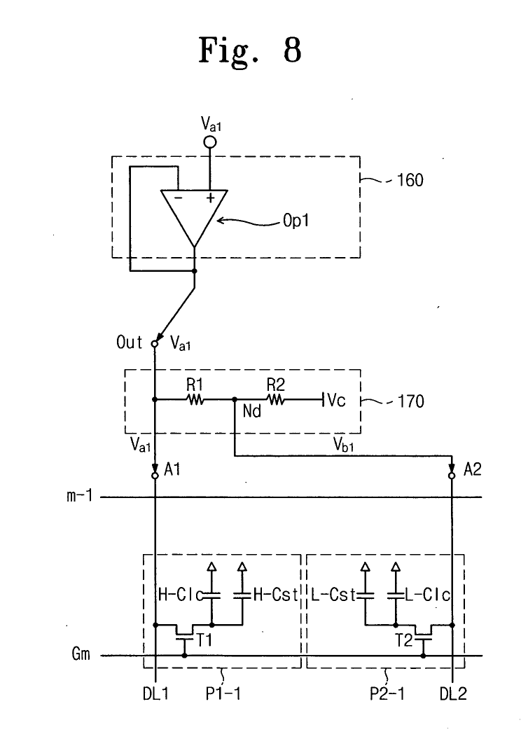

FIG. 7 is a block diagram showing another exemplary embodiment of a liquid crystal display according to the present invention, and FIG. 8 is a circuit diagram showing a part of a display part and a data driver of FIG. 7.

Referring to FIG. 7, a liquid crystal display 700 includes a timing controller 300, a data driver 105, a gamma voltage generator 400, a gate driver 500 and a display part 600.

The timing controller 300 receives image data signals R, G and B in digital form and various control signals from an exterior. The timing controller 300 provides the image data signals R, G and B to the data driver 105 using a reduced swing differential signaling (RSDS) digital interface technology. The timing controller 300 outputs control signals (e.g. a horizontal synchronization signal Hsync, a horizontal clock signal H_{CLK}, a vertical start signal STV, a clock signal CKV and a clock bar signal CKVB) that are required to operate the data driver 105 and the gate driver 500 based on the various control signals.

In the present exemplary embodiment, the gamma voltage generator 400 includes a resistor-string structure and receives a driving voltage VDD to output first to i-th gamma reference voltages V_{GAMMA1}˜V_{GAMMAi} of which voltage levels are sequentially increased by the same voltage level with each other. The first to i-th gamma reference voltages V_{GAMMA1}˜V_{GAMMAi} output from the gamma voltage generator 400 are applied to the data driver 105.

The horizontal synchronization signal Hsync and the horizontal clock signal H_{CLK} generated from the timing controller 300 are applied to the data driver 105, and the data driver 105 receives the image data signals R, G and B from the timing controller 300 in synchronization with the horizontal synchronization signal Hsync and the horizontal clock signal H_{CLK}.

The data driver 105 receives the image data signals R, G, B of one line (the image data signals of one line represent n image data signals) from the timing controller 300 to output the 2n pixel voltages. More specifically, the data driver 105 receives the n image data signals R, G and B and converts the n image data signals R, G and B into the analog form based on the first to i-th gamma reference voltages V_{GAMMA1}˜V_{GAMMAi} to output first to n-th main pixel voltages Va1˜Van. Simultaneously, the data driver 105 outputs the first to n-th sub-pixel voltages Vb1˜Vbn having the lower voltage levels than those of the first to n-th main pixel voltages Va1˜Van.

The data driver 105 has the same structure and function as those of the data driving device shown in FIG. 1, and thus detailed descriptions of the data driver 105 in FIG. 7 will be omitted.

The gate driver 500 includes a shift register that starts its operation in response to the vertical start signal STV. Each stages of the shift register is sequentially turned on in response to the clock signal CKV and the clock bar signal CKVB to sequentially output a gate signal having a voltage level corresponding to a gate-on voltage Von.

The display part 600 includes first to 2n-th data lines DL1˜DL2n, first to m-th gate lines GL1˜GLm. The first to 2n-th data lines DL1˜DL2n are insulated from and intersected with the first to m-th data lines GL1˜GLm. The display part 600 includes a plurality of pixel areas in a matrix configuration that are defined by the first to 2n-th data lines DL1˜DL2n and the first to m-th gate lines DL1˜DLm.

As shown in FIG. 8, each of the pixel areas, of which pixel area PX1 is representative, includes a main pixel region P1-1 and a sub-pixel P2-1 formed therein. In the present exemplary embodiment, a main pixel P1-1 arranged in a (mx1)th pixel area is electrically connected to a first data line DL1 and the m-th gate line GLm, and a sub-pixel P2-1 arranged in the (mx1)th pixel area is electrically connected to a second data line DL2 and the m-th gate line GLm.

The main pixel P1-1 includes a first thin film transistor T1, a main liquid crystal capacitor H-Clc and a main storage capacitor H-Cst, and the sub-pixel P2-1 includes a second sub thin film transistor T2, a sub liquid crystal capacitor L-Clc and a sub storage capacitor L-Cst.

The first to 2n-th data lines DL1˜DL2n are electrically connected to the data driver 105 to receive the first to n-th main pixel voltages Va1˜Van and the first to n-th sub-pixel voltages Vb1˜Vbn. In the present exemplary embodiment, the first data line DL1 and the second data line DL2 receive the first main pixel voltage Va1 and the first sub-pixel voltage Vb1, respectively.

Referring to FIG. 8, the first output terminal A1 and the second output terminal A2 of the data driver 105 are electrically connected to the first data line DL1 and the second data line DL2, respectively, to apply the first main pixel voltage Va1 and the first sub-pixel voltage Vb1 to the first pixel P1-1 and the second pixel P2-1.

The first output terminal A1 is electrically connected to the output terminal Out of the first Op-amp Op1, the first main pixel voltage Va1 output from the first Op-amp Op1 is output through the first output terminal A1. Since the second output terminal A2 is connected to the node Nd where a first resistor R1 and a second resistor R2 are connected to each other, the first main pixel voltage Va1 is voltage-divided by the first resistor R1 and the second resistor R2 to output the first sub-pixel voltage Vb1 having the lower voltage level than that of the first main pixel voltage Va1 through the second output terminal A2.

Thus, the data driver 105 includes only one Op-amp in order to drive two pixels arranged in one pixel area, so that the size of the output buffer 160 may decrease, thereby reducing the of manufacturing cost of the liquid crystal display 700.

According to the above, the data driving device employed in the S-PVA mode display apparatus includes the voltage divider that outputs the main and sub-pixel voltages having different voltage levels from each other based on the data voltage. The voltage divider may be arranged next to the D/A converter or the output buffer.

Thus, the size of the D/A converter may decrease and the number of Op-amps arranged in the output buffer may decrease, thereby reducing the whole size and the manufacturing cost of the data driving device.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A data driving device comprising:
an input circuitry adapted to receive image data signal in a digital form from an external source;
a converter coupled to the input circuitry and being adapted to receive the digital image data signal and convert the image digital data signal to an analog signal;
an output buffer coupled to an output of the converter, the output buffer being operative to amplify the data voltage; and
a voltage divider coupled to an output of the output buffer, the voltage divider being operative to provide a plurality of pixel voltages having different voltage levels from each other.

2. The data driving device of claim 1, wherein the voltage divider comprises:
a first resistor and a second resistor connected in series between an output terminal of the output buffer outputting the data voltage and a voltage input terminal;
a first output terminal connected to the output terminal of the output buffer to output the data voltage as a first pixel voltage; and
a second output terminal connected to a node to which the first and second resistors are commonly connected, a magnitude of the resistances of the first and second resistors and a magnitude of the voltage at the input terminal being such that a magnitude of the second pixel voltage V2 is less than a magnitude of the first pixel voltage.

3. The data driving device of claim 2, wherein the second pixel voltage satisfies an equation as follows:
$$V 2 = \frac{R 2}{R 1 + R 2} ( V 1 - Vc ) + Vc$$
where V1 is the first pixel voltage, V2 is the second pixel, V1 is a voltage applied to the voltage input terminal, R1 is the resistance value of the first resistor, and R2 is the resistance value of the second resistor.

4. The data driving device of claim 2, wherein the voltage input terminal receives a common voltage from an external source.

5. The data driving device of claim 1, wherein the voltage divider comprises:
a first capacitor and a second capacitor connected in series between an output terminal of the output buffer outputting the data voltage and a voltage input terminal;
a first output terminal connected to the output terminal of the output buffer to output the data voltage as a first pixel voltage; and
a second output terminal electrically connected to a node to which the first and second capacitors are commonly connected, a magnitude of the capacitance of the first and second capacitors and a magnitude of the voltage at the input terminal being such that a magnitude of the second pixel voltage is less than a magnitude of the first pixel voltage.

6. The data driving device of claim 5, wherein the second pixel voltage satisfies an equation as follows:
$$V 2 = \frac{C 1}{C 1 + C 2} ( V 1 - Vc ) + Vc$$
where V1 is the first pixel voltage, V2 is the second pixel voltage, Vc is a voltage applied to the voltage input terminal, C1 is the capacitance value of the first capacitor, and C2 is the capacitance value of the second capacitor.

7. The data driving device of claim 5, wherein the voltage input terminal receives a common voltage from an external source.

8. The data driving device of claim 1, wherein the input circuitry comprises:
a shift register adapted to sequentially output a selection signal in response to a synchronization signal from an external source;
an input register coupled to the shift register and being adapted to receive the image data signal from an external source in synchronization with the selection signal; and
a storage register coupled to the input register to substantially simultaneously receive the image data signal of one line from the input register in response to a load control signal from the external source to store the image data signal of one line.

9. A data driving device comprising:
an input circuitry adapted to receive image data signal in a digital form from an external source;
a converter coupled to the input circuitry and being adapted to receive the digital image data signal and convert the image digital data signal to an analog signal;
a voltage divider coupled to an output of the converter, the voltage divider being adapted to generate and output a first pixel voltage and a second pixel voltage having a different voltage level from that of the first pixel voltage; and
an output buffer coupled to the voltage divider and being adapted to amplify the first pixel voltage and the second pixel voltage and output the amplified first and second pixel voltages.

10. The data driving device of claim 9, wherein the output buffer comprises:
a first operational amplifier coupled to receive and amplify the first pixel voltage from the voltage divider; and
a second operational amplifier coupled to receive and amplify the second pixel voltage output from the voltage divider.

11. The data driving device of claim 9, wherein the voltage divider comprises:
a first resistor and a second resistor connected in series between an output terminal of the converter outputting the first pixel voltage and a voltage input terminal;
a first output terminal connected to the output terminal of the converter to output the first pixel voltage; and
a second output terminal connected to a node where the first and second resistors are connected to each other to output the second pixel voltage.

12. The data driving device of claim 11, wherein the voltage input terminal receives a common voltage from an external source.

13. The data driving device of claim 9, wherein the voltage divider comprises:
a first capacitor and a second capacitor connected in series between an output terminal of the converter outputting the first pixel voltage and a voltage input terminal;
a first output terminal connected to an output terminal of the output buffer to output the first pixel voltage; and
a second output terminal electrically connected to a node where the first and second capacitors are connected to each other to output the second pixel voltage having a lower voltage level than that of the first pixel voltage.

14. A display apparatus comprising:
a display comprising a plurality of pixel regions to display an image, each of the pixel regions including a first pixel and a second pixel displaying different gray-scales, and wherein the first pixel and second pixel receive respectively the first and second pixel voltages in response to a gate signal, respectively;
a gate driver sequentially outputting a gate signal; and
a data driver substantially simultaneously outputting a first pixel voltage having a first magnitude and a second pixel voltage having a different magnitude, wherein the data driver comprises:
an input circuitry adapted to receive image data signal;
a converter coupled to the input circuitry and being adapted to receive the image data signal and convert the image digital data signal to an analog signal; based on a gamma reference voltage;
an output buffer adapted to receive the image data signal in the analog form from the converter and amplify the image data signal in the analog form to the first pixel voltage; and
a voltage divider coupled to the output buffer to receive the first pixel voltage from the output buffer and output the first pixel voltage and the second pixel voltage.

15. The display apparatus of claim 14, wherein the voltage divider comprises:
a first output terminal connected to an output terminal of the output buffer to output the first pixel voltage;
a second output terminal outputting the second pixel voltage having a lower voltage level than that of the first pixel voltage;
a first resistor arranged between the output terminal of the output buffer outputting the first pixel voltage and the second output terminal; and
a second resistor arranged between the second output terminal and a voltage input terminal and connected to the first resistor in series.

16. The display apparatus of claim 14, wherein the voltage divider comprises:
a first output terminal connected to an output terminal of the output buffer to output the first pixel voltage;
a second output terminal outputting the second pixel voltage having a lower voltage level than that of the first pixel voltage;
a first capacitor arranged between the output terminal of the output buffer outputting the first pixel voltage and the second output terminal; and
a second capacitor arranged between the second output terminal and a voltage input terminal and connected to the first capacitor in series.

17. The display apparatus of claim 14, wherein the display part comprises:
a plurality of gate lines sequentially receiving the gate signal;
a plurality of first data lines receiving the first pixel voltage; and
a plurality of second data lines receiving the second pixel voltage.

18. The display apparatus of claim 14, further comprising:
a timing controller providing the image data signal to the input circuitry; and
a gamma voltage generator providing the gamma reference voltage to the converter.

19. A method of driving a data driving device, comprising:
receiving an image data signal in a digital form from an exterior;
converting the image data signal into a data voltage in an analog form;
amplifying the data voltage; and
outputting the amplified data voltage as a plurality of pixel voltages having different voltage levels from each other.

20. A method of driving a data driving device, comprising:
receiving an image data signal in a digital form from an exterior;
converting the image data signal into a first pixel voltage in an analog form;
outputting the first pixel voltage and outputting a second pixel voltage having a different voltage level from that of the first pixel voltage based on the first pixel voltage; and
amplifying the first pixel voltage and the second pixel voltage.

21. The method of claim 20, wherein the second pixel voltage has a lower voltage level than that of the first pixel voltage.
